(19) United States
(12) Patent Application Publication
(10) Pub. No.: US 2020/0005167 A1
(43) Pub. Date: Jan. 2, 2020

(54) SUBCONSCIOUS ESTIMATION SYSTEM, SUBCONSCIOUS ESTIMATION METHOD, AND SUBCONSCIOUS ESTIMATION PROGRAM

(71) Applicant: INSTITUTION FOR A GLOBAL SOCIETY K.K., TOKYO (JP)

(72) Inventors: Masahiro FUKUHARA, TOKYO (JP); Kuniharu ARAMAKI, TOKYO (JP); Yutaka KANOU, TOKYO (JP); Mitsuru KIMURA, TOKYO (JP)

(21) Appl. No.: 16/080,524

(22) PCT Filed: Mar. 11, 2016
(86) PCT No.: PCT/JP2016/057833

§ 371 Date: Aug. 28, 2018

(51) Int. Cl. G06N 5/04; G06N 20/00; G06F 3/041; G06F 3/0488; G06F 3/0482

(52) U.S. Cl. CPC G06N 5/04; G06N 20/00; G06F 2203/04803; G06F 3/04886; G06F 3/0482; G06F 3/041

(57) ABSTRACT

The subconscious mind estimation system includes: an image display control unit 111 which causes an image display unit 13 to display first classification destination images 1211, 1212, 1213, and 1214, representing each of first type concepts and representing each of second type concepts, and first target images 1241 and 1251, corresponding to one of the first type concept and the second type concept; an operation trajectory recognition unit 112 which recognizes a first operation trajectory via an operation detection unit 14; and a subconscious mind estimation unit 113 which estimates the subconscious mind of the subject S about a tie between the first type concept and the second type concept based on the first operation trajectory.

### TECHNICAL FIELD

The present invention relates to a subconscious mind estimation system, a subconscious mind estimation method, and a subconscious mind estimation program.

### BACKGROUND ART

There is known a test for use in estimating a subconscious mind (for example, refer to Patent Document 1), which is called “implicit association test (IAT)” or “implicit test of associations (ITA).”

As described in Patent Document 1, this test is used to estimate the subconscious mind of the subject about a tie between a pair of concepts such as “flower” and “insect” (hereinafter, referred to as “first type pair concepts”) and a pair of concepts, which is different from the foregoing pair of concepts, such as “pleasant” and “unpleasant” (hereinafter, referred to as “second type pair concepts”).

The system which performs this test displays, for example, an image representing a combination of one of the first type pair concepts and one of the second type pair concepts in the upper left of the screen, displays an image representing a combination of the other of the first type pair concepts and the other of the second type pair concepts in the upper right of the screen, and displays a target image which corresponds to one of the first type pair concepts or the second type pair concepts in the center of the screen.

For example, the system displays an image representing a combination of “flower” and “pleasant” in the upper left of the screen, displays an image representing a combination of “insect” and “unpleasant” in the upper right of the screen, and displays a target image which corresponds to one of them (for example, an image of “rose” corresponding to “flower”) in the center of the screen.

In addition, the system measures the time between when these target images are displayed and when a predetermined key of a keyboard associated with the combination in the upper left or a predetermined key of the keyboard associated with the combination in the upper right is pressed.

After repeating the display of the target images and the measurement of the time a predetermined number of times, the system changes the way of combination of the first type pair concept and the second type pair concept and then measures the time to response again.

For example, the system performs the above processing with respect to a combination of “flower” and “pleasant” and a combination of “insect” and “unpleasant” (hereinafter, a test in this processing will be referred to as “first test”) and thereafter performs the above processing with respect to a combination of “flower” and “unpleasant” and a combination of “insect” and “pleasant” (hereinafter, a test in this processing will be referred to as “second test”).

The system then compares an average value of the time to response in the first test with an average value of the time to response in the second test.

If a subject has a subconscious mind that “a flower is pleasant and an insect is unpleasant,” the subject may feel pleased unconsciously when an image corresponding to “flower” is displayed.

In this case, the subject is able to give a response in a short time in the first test in which the combination of “flower” and “pleasant and the combination of “insect” and “unpleasant” are used, since the combinations match the subconscious mind of the subject, while the subject is likely to require a plenty of time to respond in the second test in which the combination of “flower” and “unpleasant” and the combination of “insect” and “pleasant” are used, since the combinations diverge from the subconscious mind of the subject.

In other words, if the average response time in the above first test is shorter than the average response time in the second test, it is highly probable that the subject has a subconscious mind that there is a strong tie in combination of concepts (“flower” and “pleasant,” “insect” and “unpleasant”) in the first test.

On the basis of the presumption, the system estimates that the larger the divergence between the average value of the time to response in the first test and the average value of the time to response in the second test is, the stronger the tie in either of the combinations is.

### CITATION LIST

### Patent Literature

Patent Literature 1: U.S. Pat. No. 8,696,360

### SUMMARY OF INVENTION

### Technical Problem

There is, however, still room for improvement in the above conventional test from the viewpoint of improving an estimation accuracy.

More specifically, for example, even in the case where the average response time for a combination of certain concepts is short, it cannot be determined whether the subject has felt a strong tie in the combination or the subject pressed the key without thinking in the rush to give a response, and as a result, the average response time happens to be short. Consequently, the subconscious mind is likely to be incorrectly estimated in the above test.

In view of the above problem, it is an object of the present invention to provide a system, a method, and a program capable of estimating the subconscious mind of a subject with high accuracy.

### Solution to Problem

According to the present invention, there is provided a subconscious mind estimation system including: an image display unit which displays an image; an operation detection unit which is formed integrally with the image display unit and is able to detect a touch operation of a subject; a classification processing unit which displays M first classification destination images (M is an integer satisfying M≥2, M≤K, and M≤L), which are still images or moving images each including a combination of at least one of characters, a symbol, a numeral, a figure, an object image, a pattern, and a color representing each of K first type concepts (K is an integer satisfying K≥2) and at least one of characters, a symbol, a numeral, a figure, an object image, a pattern, and a color representing each of L second type concepts (L is an integer satisfying L≥2) different from each of the first type concepts, and a first target image, which is a still image or a moving image including at least one of characters, a symbol, a numeral, a figure, an object image, a pattern, and a color corresponding to any one of the K first type concepts and the L second type concepts on the image display unit, and then continues to display the first target image on the image display unit until detecting that at least both of a touch operation of the subject on the first target image and a touch operation of the subject on one of the first classification destination images are performed via the operation detection unit; and a subconscious mind estimation unit which estimates a subconscious mind of the subject about a tie between the first type concept and the second type concept based on the touch operations of the subject detected by the classification processing unit.

According to the subconscious mind estimation system having the above configuration, the first classification destination images and the first target image are displayed on the image display unit.

The first classification destination image is a still image or a moving image including a combination of at least one of characters, a symbol, a numeral, a figure, an object image, a pattern, and a color (hereinafter, appropriately referred to as “characters or the like”) representing each of K first type concepts and characters or the like representing each of L second type concepts. In addition, the first target image is a still image or a moving image including characters or the like corresponding to any one of the K first type concepts and the L second type concepts.

Since the first type concept, the second type concept, and those corresponding thereto are represented by characters or the like, the subject is able to recognize the combination of the first type concept and the second type concept and a classification target properly.

Then, the classification processing unit continues to display the first target image on the image display unit until detecting that at least both of a touch operation of the subject on the first target image and a touch operation of the subject on one of the first classification destination images are performed via the operation detection unit.

Specifically, the classification ends when meeting a requirement that both of the touch operation of the subject on the first target image and the touch operation of the subject on one of the first classification destination images are detected.

In other words, the classification of the first target image into the first classification destination image does not end by detecting only one of the touch operation on the first target image and the touch operation on one of the first classification destination images via the operation detection unit. Therefore, even in the case where the same first classification destination image is accidentally touched twice in a row after touching the first target image, for example, in the case where classification is performed repeatedly, the first touch enables the end of the current classification, but the second touch does not end the next classification, and therefore the first target image is not classified into the first classification destination image contrary to the subject's intention.

This enables the subject to think for a relatively long time before classifying the first target image into the first classification destination image, thereby avoiding a situation in which the subject selects the first classification destination image without thinking well in the rush to give a response.

Therefore, the touch operation of the subject in the classification more reflects the subconscious mind of the subject. Therefore, the subconscious mind estimation unit estimates the subconscious mind of the subject about the tie between the first type concept and the second type concept on the basis of the touch operations of the subject, thereby enabling the subconscious mind of the subject to be estimated with high accuracy.

Preferably, in the subconscious mind estimation system of the present invention, in the case where the display screen of the image display unit is divided into three equal parts including an upper part, a center part, and a lower part of the display screen, the classification processing unit displays the M first classification destination images and the first target image on the image display unit so that all of the center positions of the M first classification destination images are included in the upper part and the center position of the first target image is included in the lower part.

According to the subconscious mind estimation system having the above configuration, the M first classification destination images and the first target image are displayed on the image display unit so that all of the center positions of the M first classification destination images are included in the upper part and the center position of the target image is included in the lower part. Thereby, the distance between the first target image and the first classification destination image is relatively long, which slightly increases the time before both of the touch operation on the first target image and the touch operation on one of the first classification destination images are performed.

This enables the subject to think for a longer time before classifying the first target image into the first classification destination image, thereby avoiding a situation in which the subject selects the first classification destination image without thinking well in the rush to give a response.

Accordingly, the touch operation of the subject in the classification more reflects the subconscious mind of the subject. Therefore, the subconscious mind estimation unit estimates the subconscious mind of the subject about the tie between the first type concept and the second type concept on the basis of the touch operations of the subject, thereby enabling the subconscious mind of the subject to be estimated with higher accuracy.

Preferably, in the subconscious mind estimation system of the present invention, the classification processing unit is configured to recognize a first operation trajectory, which is a trajectory of touch operations of the subject obtained until both of the touch operation on the first target image and the touch operation on the first classification destination image are performed, via the operation detection unit; and the subconscious mind estimation unit is configured to estimate the subconscious mind of the subject about the tie between the first type concept and the second type concept based on the first operation trajectory.

According to the subconscious mind estimation system having the above configuration, the classification processing unit recognizes the first operation trajectory via the operation detection unit.

The first operation trajectory reflects the subject's state of mind. Therefore, the operation trajectory detected when the subject gives a response with confidence is different from the operation trajectory detected when the subject gives a response without confidence or after temporarily hesitating. Moreover, if the subject changes the operation mode since noticing an error in the middle of giving a response even in the case of being in the rush to give the response, it is highly probable that the operation trajectory is different from an operation trajectory detected when the subject selects a correct response directly.

Additionally, each first classification destination image is a still image or a moving image representing a combination of characters or the like representing each of the first type concepts and characters or the like representing each of the second type concepts different from each of the first type concepts. If the combination of the first type concept and the second type concept illustrated in each first classification destination image matches the subconscious mind of the subject, it is highly probable that the subject selects a correct response with confidence. If the combination of the first type concept and the second type concept illustrated in each first classification destination image diverges from the subconscious mind of the subject, it is highly probable that the subject selects a response without confidence or after hesitating or changes the operation in the middle of selecting a response.

In this manner, it is highly probable that the first operation trajectory reflects the subconscious mind of the subject. Therefore, the subconscious mind estimation unit estimates the subconscious mind of the subject about the tie between the first type concept and the second type concept on the basis of the first operation trajectory, thereby enabling the subconscious mind of the subject to be estimated with high accuracy.

Preferably, in subconscious mind estimation system of the present invention, the subconscious mind estimation unit is configured to evaluate a divergence between the first operation trajectory and a predetermined operation trajectory and to estimate the subconscious mind of the subject such that, when the divergence is smaller, there is a stepwise or continuous stronger tie in combination of the first type concept and the second type concept displayed on the image display unit.

If the combination of the first type concept and the second type concept displayed on the image display unit matches the subconscious mind of the subject, it is highly probable that the first operation trajectory is the same as a certain operation trajectory. On the other hand, if the combination of the first type concept and the second type concept displayed on the image display unit diverges from the subconscious mind of the subject, it is highly probable that the first operation trajectory differs from the certain operation trajectory.

According to the subconscious mind estimation system configured focusing on this matter, the subconscious mind estimation unit evaluates the divergence between the first operation trajectory and the predetermined operation trajectory.

Then, when the divergence is smaller, in other words, in the case where it is assumed that the combination of the first type concept and the second type concept displayed on the image display unit matches the subconscious mind of the subject, the subconscious mind estimation unit estimates that there is a strong tie in combination of the first type concept and the second type concept displayed on the image display unit.

Therefore, according to the subconscious mind estimation system having the above configuration, the subconscious mind of the subject about the tie between the first type concept and the second type concept can be estimated with high accuracy.

Preferably, in the subconscious mind estimation system having the above configuration, the classification processing unit is configured to display M second classification destination images, which are still images or moving images each including at least one of characters, a symbol, a numeral, a figure, an object image, a pattern, and a color representing each of the first type concept or the second type concept, and a second target image, which includes at least one of characters, a symbol, a numeral, a figure, an object image, a pattern, and a color corresponding to one of the concepts illustrated in the M second classification destination images, on the image display unit and to recognize a second operation trajectory, which is a trajectory of touch operations of the subject obtained until both of the touch operation on the second target image and the touch operation on the second classification destination image are performed, via the operation detection unit; and the subconscious mind estimation unit is configured to set the predetermined operation trajectory based on the second operation trajectory.

According to the subconscious mind estimation system having the above configuration, the characters or the like included in the second classification destination image are not a combination of the characters or the like representing the first type concept and the characters or the like representing the second type concept, but characters or the like representing one of the first type concept and the second type concept, unlike the first type classification destination image, and therefore the subject is able to select the second classification destination image without hesitation at all.

In other words, the second operation trajectory for selecting the relatively simple second classification destination image is an operation trajectory close to the operation trajectory obtained when the combination of the first type concept and the second type concept illustrated in each first classification destination image matches the subconscious mind of the subject.

The subconscious mind of the subject is estimated on the basis of the divergence between the predetermined operation trajectory, which is set based on the second operation trajectory, and the first operation trajectory, by which the subconscious mind of the subject about the tie between the first type concept and the second type concept can be estimated with higher accuracy.

Preferably, in the subconscious mind estimation system having the above configuration, the second classification destination image includes at least one of the same characters, symbol, numeral, figure, object image, pattern, and color as at least one of the characters, symbol, numeral, figure, object image, pattern, and color representing each of the first type concepts included in the first classification destination image or as at least one of the characters, symbol, numeral, figure, object image, pattern, and color representing each of the second type concepts included in the first classification destination image; and the second target image includes at least one of the same characters, symbol, numeral, figure, object image, pattern, and color as at least one of the characters, symbol, numeral, figure, object image, pattern, and color included in the first target image.

According to the subconscious mind estimation system having the above configuration, the second classification destination image includes the same characters or the like as the characters or the like representing each of the first type concepts or the second type concepts included in the first classification destination image and the second target image includes the same characters or the like as the characters or the like included in the first target image. Therefore, the information provided to the subject when the first target image and the first classification destination image are displayed can be substantially matched with the information provided to the subject when the second target image and the second classification destination image are displayed.

Therefore, the second operation trajectory is made closer to the operation trajectory obtained when the combination of the first type concept and the second type concept illustrated in each first classification destination image matches the subconscious mind of the subject.

As a result, the subconscious mind of the subject is estimated on the basis of the divergence between the predetermined operation trajectory, which is set based on the second operation trajectory, and the first operation trajectory, by which the subconscious mind of the subject about the tie between the first type concept and the second type concept can be estimated with higher accuracy.

Preferably, in the subconscious mind estimation system of the present invention, in the case where both of the first type concept and the second type concept represented by at least one of the characters, symbol, numeral, figure, object image, pattern, and color included in the touched first classification destination image are different from the first type concept or the second type concept associated with at least one of the characters, symbol, numeral, figure, object image, pattern, and color included in the first target image, the subconscious mind estimation unit is configured to estimate the subconscious mind of the subject that there is a weak tie between the first type concept and the second type concept which are associated with at least one of the characters, symbol, numeral, figure, object image, pattern, and color included in the first classification destination image based on the touch operations of the subject performed both of the touch operation on the first target image and the touch operation on the touched first classification destination image are performed.

In the above, in the case where both of the first type concept and the second type concept represented by the characters or the like included in the touched first classification destination image are different from the first type concept or the second type concept associated with the characters or the like included in the first target image, it is estimated that the subject has a subconscious mind that there is a strong tie between the first type concept or the second type concept associated with the characters or the like included in the first target image and one of the first type concept and the second type concept associated with the characters or the like included in the touched first classification destination image.

In other words, it is estimated that the subject has a subconscious mind that there is a weak tie between the first type concept and the second type concept associated with the characters or the like included in the selected first classification destination image.

According to the subconscious mind estimation system having the above configuration configured focusing on this matter, regarding both of the first type concept and the second type concept represented by the characters or the like included in the touched first classification destination image, the subconscious mind of the subject is estimated such that there is a weak tie between the first type concept and the second type concept associated with the characters or the like included in the first target image on the basis of the touch operations of the subject detected until both of the touch operation on the first target image and the touch operation on the touched first classification destination image are performed, and therefore the subconscious mind of the subject is estimated with high accuracy.

Preferably, in the subconscious mind estimation system of the present invention, in the case where both of the first type concept and the second type concept represented by at least one of the characters, symbol, numeral, figure, object image, pattern, and color included in the touched first classification destination image are different from the first type concept or the second type concept associated with at least one of the characters, symbol, numeral, figure, object image, pattern, and color included in the first target image, the classification processing unit displays an image for prompting reselection of the first classification destination image for the same first target image on the image display unit and the subconscious mind estimation unit is configured to estimate the subconscious mind of the subject about the tie between the first type concept and the second type concept based on touch operations of the subject performed until before the display of the image for prompting reselection, which have been detected by the classification processing unit.

According to the subconscious mind estimation system having the above configuration, in the case where both of the first type concept and the second type concept represented by characters or the like included in the selected first classification destination image are different from the first type concept or the second type concept associated with the characters or the like included in the first target image, an image for prompting reselection of the first classification destination image is displayed on the image display unit for the same first target image.

This enables the subject to recognize that the incorrect response is not accepted. Therefore, it is possible to prompt the subject to respond more carefully.

In addition, the subconscious mind estimation unit estimates the subconscious mind of the subject about the tie between the first type concept and the second type concept based on touch operations of the subject until before the image for prompting reselection is displayed, which have been detected by the classification processing unit.

In the above, the touch operations detected until before the display of the image for prompting reselection reflect the subconscious mind of the subject, while it is considered that the touch operations after the display of the image for prompting reselection do not reflect the subconscious mind of the subject, since the subject clearly recognizes that one selection is incorrect in the touch operations.

Therefore, the subconscious mind of the subject is estimated about the tie between the first type concept and the second type concept on the basis of the touch operations detected until before the display of the image for prompting reselection, thereby enabling the subconscious mind of the subject to be estimated with higher accuracy.

### BRIEF DESCRIPTION OF DRAWINGS

FIG. 1 is a general configuration diagram of a subconscious mind estimation system according to the present invention.

FIG. 2 is a flowchart of the entire subconscious mind estimation processing.

FIG. 3A is a diagram for describing an image in which second classification destination images each including characters or the like representing each of first type concepts and a target image including characters or the like corresponding to one of the first type concepts are displayed on a client image display unit.

FIG. 3B is a diagram for describing an image in which second classification destination images each including characters or the like representing each of second type concepts and a target image including characters or the like corresponding to one of the second type concepts are displayed on the client image display unit.

FIG. 3C is a diagram for describing an image in which first classification destination images each including a combination of characters or the like representing each of the first type concepts and characters or the like representing each of the second type concepts and a target image including characters or the like corresponding to one of the first type concept or the second type concept are displayed on the client image display unit.

FIG. 3D is a diagram for describing an image in which the second classification destination images each including characters or the like representing each of the second type concepts after a change in the display position of the second type concepts and a target image including characters or the like corresponding to one of the second type concepts are displayed on the client image display unit.

FIG. 3E is a diagram illustrating a state in which the client image display unit displays first classification destination images each including a combination of characters or the like representing each of the first type concepts and characters or the like representing each of the second type concepts and a target image including characters or the like corresponding to one of the first type concept or the second type concept.

FIG. 3F is a diagram for describing an image displayed on the client image display unit in the case of prompting reselection.

FIG. 4 is a flowchart of training processing or test processing.

FIG. 5A is a diagram illustrating an operation trajectory mode in the case of classifying the target image into one of the second classification destination images.

FIG. 5B is a diagram illustrating an operation trajectory mode in the case of classifying the target image into one of the first classification destination images.

FIG. 5C is a diagram illustrating an example of an operation trajectory mode in the case of incorrectly selecting the first classification destination image for the target image.

FIG. 5D is a diagram illustrating an operation trajectory mode in the case where reselection is prompted.

FIG. 6 is a diagram illustrating the contents of operation information.

FIG. 7 is a flowchart of estimation processing of the subconscious mind of a subject.

### DESCRIPTION OF EMBODIMENTS

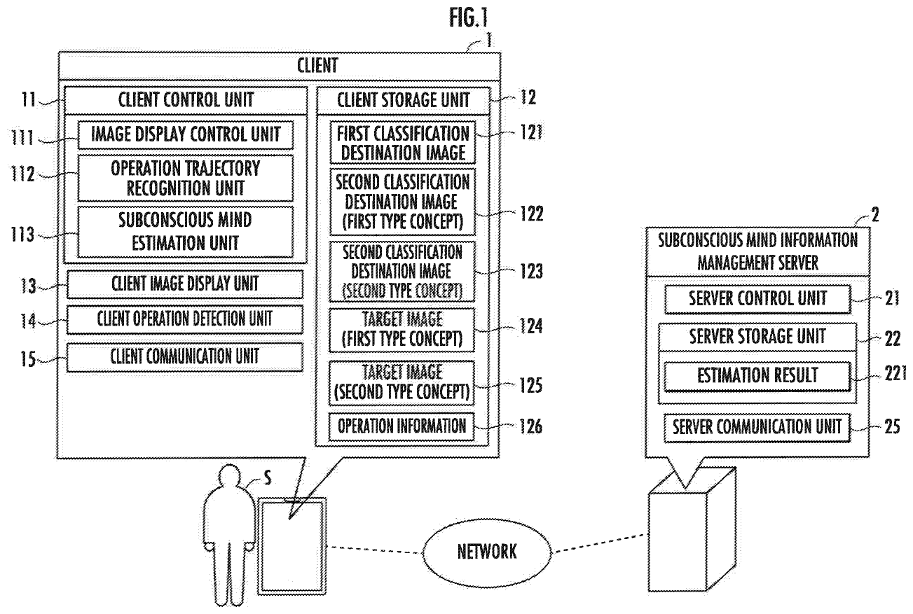

A subconscious mind estimation system according to the present invention will be described with reference to FIGS. 1 to 7.

(Subconscious Mind Estimation System)

The subconscious mind estimation system is a system which estimates the strength of a tie between one concept in the subconscious mind of a subject S (a concept such as “myself,” “another person,” or the like) and any other concept different from the foregoing concept (for example, a concept such as “extrovert,” “introvert,” or the like). The information generated by this system is used, for example, as basic information used by a job seeker to find a compatible company or information used by a company to select a job seeker.

The subconscious mind estimation system includes a client 1 and a subconscious mind information management server 2, as illustrated in FIG. 1, in order to estimate the strength of a tie between one concept in the subconscious mind of the subject S and the other concept different from this concept and to enable the estimated information to be used by the subject S or another person.

(Client)

The client 1 includes a client control unit 11, a client storage unit 12, a client image display unit 13, a client operation detection unit 14, and a client communication unit 15. Note that the “client image display unit 13” corresponds to the “image display unit” of the present invention and the “client operation detection unit 14” corresponds to the “operation detection unit” of the present invention.

The client 1 may be composed of a computer designed in size, shape, and weight in such a way that the subject S is able to carry the computer such as a tablet-type terminal or a smartphone or may be composed of a computer designed in size, shape, and weight in such a way as to be installed in a specific location such as a desktop computer.

The client control unit 11 includes an arithmetic processing unit such as a central processing unit (CPU), a memory, an input/output (I/O) device, and the like. In the client control unit 11, an externally-downloaded subconscious mind estimation program is installed. The client control unit 11 is configured to function as an image display control unit 111, an operation trajectory recognition unit 112, and a subconscious mind estimation unit 113 which perform arithmetic processing described later, by the start of the subconscious mind estimation program. Note here that the image display control unit 111 and the operation trajectory recognition unit 112 constitute the “classification processing unit” of the present invention.

The image display control unit 111 is configured to adjust a display image in the client image display unit 13.

The operation trajectory recognition unit 112 is configured to recognize a mode of a touch operation of the subject S in the client operation detection unit 14. The touch operation includes a tap (single tap, double tap, and long tap), a flick (up flick, down flick, left flick, and right flick), a swipe, a pinch (pinch-in and pinch-out) or a multi-touch, and the like.

The client storage unit 12 is composed of a storage device such as, for example, a read-only memory (ROM), a random-access memory (RAM), a hard disk drive (HDD), or the like. The client storage unit 12 stores a first classification destination image 121, a second classification destination image (first type concept) 122, a second classification destination image (second type concept) 123, a target image (first type concept) 124, a target image (second type concept) 125, and operation information 126.

These images may be downloaded together with the subconscious mind estimation program, may be stored by using an image capturing function or the like of the client 1, may be stored or created during execution of the subconscious mind estimation program on the basis of information on the subject S stored in the client storage unit 12, or may be stored or created during execution of the subconscious mind estimation program on the basis of information input via the client operation detection unit 14.

The wording “the image is stored or created during execution of the program on the basis of ‘information’ means that a still image or a moving image is stored or created by using “information” during execution of the program.

For example, the still image or moving image, which has been searched for via a network on the basis of the “information,” may be stored. A still image or a moving image including character information as the “information” on the basis of the character information. If the “information” is information indicating a numeral (for example, character information “1”), a still image or a moving image including the numeral itself (“1”) may be created. If the “information” is the name of an object (the object includes a human or an animal: for example, the name of the subject S), a still image or a moving image including a photograph of the object or a figure representing the person may be generated. If the “information” is the name of a color (for example, character information “red”), a still image or a moving image including the color may be generated. If the “information” is the name of a pattern (for example, character information “larch pattern”), a still image or a moving image including the pattern may be created. If the “information” is the name of some sort of symbol (for example, character information “integral symbol”), a still image or a moving image may be created so as to include the symbol.

Moreover, if the “information” is an RGB value indicating a color, a still image or a moving image including the name of the color may be created. If the “information” is a still image or a moving image obtained by photographing a pattern, a still image or a moving image including the name of the pattern may be created. If the “information” is a still image or a moving image obtained by photographing an object, a still image or a moving image including the name of the object may be created. If the “information” is a symbol, a still image or a moving image including the name of the symbol may be created. If the “information” is a numeral, a still image or a moving image including the reading or the like of the numeral may be created.

In the creation of these still images or moving images, a table may be appropriately used where the table lists the correspondence between information and elements included in a created image.

The first classification destination images 121 are M (M is an integer satisfying 2≤M, M≤K, and M≤L) still images or moving images each including a combination of characters or the like representing each of K (K is 2 or a greater integer) first type concepts and characters or the like representing each of L (L is 2 or a greater integer) second type concepts.

Moreover, the K (K is 2 or a greater integer) first type concepts do not overlap each other. As an example of the first type concept, there are concepts “myself” and “another person” if K=2. If K=2, the first type concepts are preferably contrasting concepts such as “myself” and “another person,” though the concepts may be different, to the extent that they are distinguished from each other such as “flower” and “insect.”

Furthermore, L (L is 2 or a greater integer) second type concepts are concepts which do not overlap each other and are different from the first type concepts. If L=2, the examples of the second type concepts include concepts such as “extrovert” and “introvert” which do not overlap each other and which are different from the first type concepts “myself” and “another person.” If K=2, the second type concepts are preferably contrasting concepts such as “extrovert” and “introvert,” though the concepts may be different, to the extent that they are distinguished from each other such as “flower” and “insect.”

The characters or the like representing each of the first type concept or the second type concept may be characters such as “myself,” “another person,” “extrovert,” “introvert,” or the like and further may be a person image of the subject S him/herself, a person image of a person other than the subject S, an object image representing the first type concept or the second type concept, a symbol representing the first type concept or the second type concept, a numeral representing the first type concept or the second type concept, a figure representing the first type concept or the second type concept, a pattern representing the first type concept or the second type concept, or a color representing the first type concept or the second type concept or may be a combination of these characters and the person image or the like.

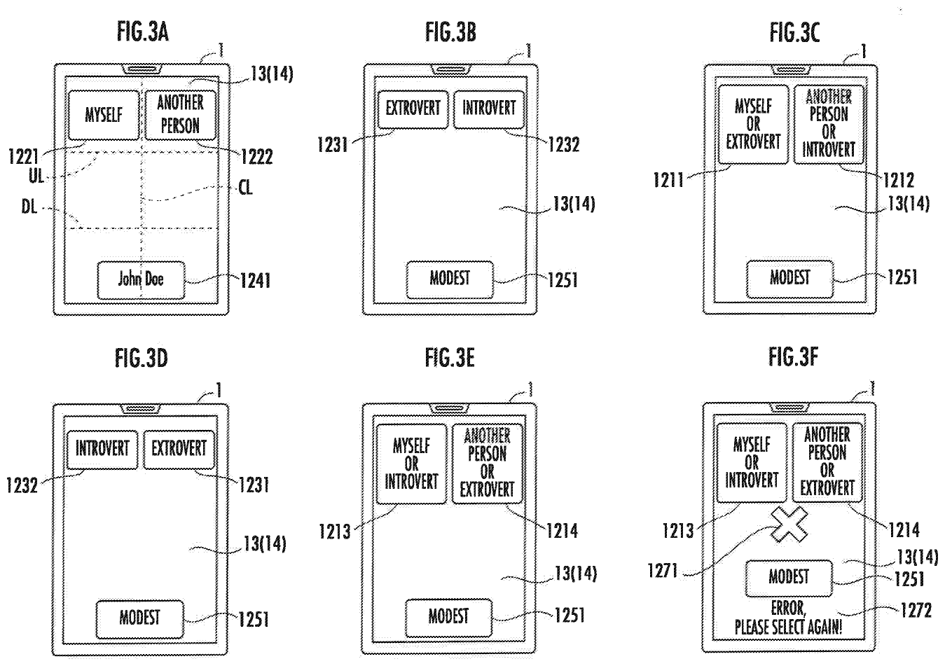

The first classification destination image 121 is a still image such as a “myself”-“extrovert” image 1211 including a combination of characters or the like representing the first type concept “myself” and characters or the like representing the second type concept “extrovert” or an “another person”-“introvert” image 1212 including a combination of characters or the like representing the first type concept “another person” and characters or the like representing the second type concept “introvert” if M=2, for example, as illustrated in FIG. 3C.

Although this embodiment will be described assuming that K=2, L=2, and M=2 for simplifying the description, the same configuration and processing may be employed if K, L, and M are each 3 or greater.

The second classification destination image (first type concept) 122 is a still image or a moving image including characters or the like representing a first type concept. The second classification destination image (first type concept) 122 is a still image such as a “myself” image 1221 including characters or the like representing the first type concept “myself” or an “another person” image 1222 including characters or the like representing the first type concept “another person” as illustrated in FIG. 3A, for example.

The second classification destination image (second type concept) 123 is a still image or a moving image including characters or the like representing a second type concept. The second classification destination image (second type concept) 123 is a still image such as an “extrovert” image 1231 including characters or the like representing the second type concept “extrovert” or an “introvert” image 1232 including characters or the like representing the second type concept “introvert” as illustrated in FIG. 3B, for example.

The target image (first type concept) 124 is a still image or a moving image including characters or the like previously associated with one of the first type concepts (characters or the like classified into one of the first type concepts [for example, characters or the like representing a subordinate concept, a specific example, or the like of one of the first type concepts]). The target image (first type concept) 124 is a still image such as a subject name image 1241 including the name “John Doe” of the subject S previously associated with a first type concept “myself” as illustrated in FIG. 3A, for example.

The target image (first type concept) 124 is also provided with appended information with which first type concept the target image (first type concept) 124 is associated.

The target image (second type concept) 125 is a still image or a moving image including characters or the like previously associated with a second type concept (characters or the like classified into one of the second type concepts [for example, characters or the like representing a subordinate concept or a specific example of one of the second type concepts]). The target image (second type concept) 125 is a still image such as a “modest” image 1251 including characters “modest” previously associated with a second type concept “introvert” as illustrated in FIG. 3B, for example.

The target image (second type concept) 125 is also provided with appended information with which second type concept the target image (second type concept) 125 is associated.

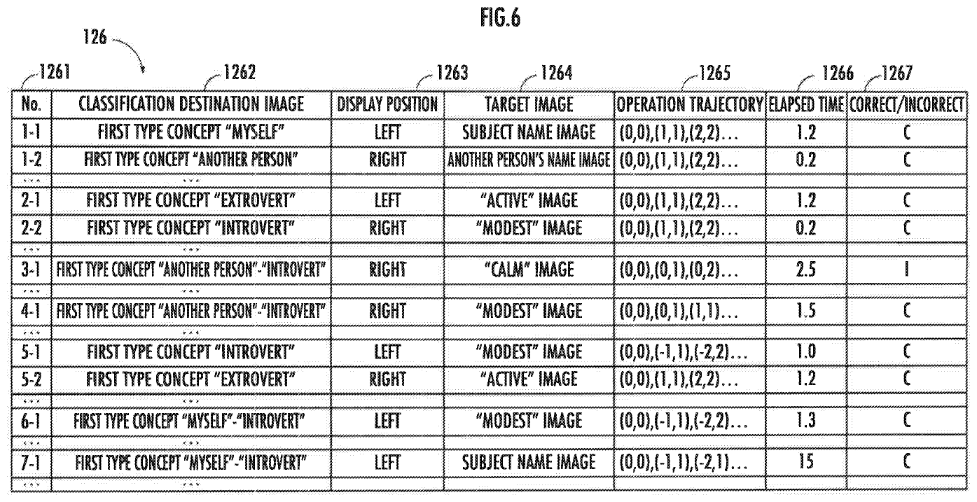

The operation information 126 is information including an operation trajectory recognized in image classification training processing and image classification test processing described later. As illustrated in FIG. 6, the operation information 126 is represented by a table containing a field number column 1261, a classification destination image column 1262, a display position column 1263, a target image column 1264, an operation trajectory column 1265, an elapsed time column 1266, and a correct/incorrect column 1267.

The value of the field number column 1261 is a unique numerical value allocated to identify each field. The value of the field number column 1261 is represented by a character string made of two numerals with a hyphen therebetween.

Note here that the value on the left side of the hyphen in the field number column 1261 indicates each processing described later. The values 1, 2, 3, 4, 5, 6, and 7 indicate first image classification training processing, first round of second image classification training processing, first round of first image classification test processing, first round of second image classification test processing, second round of second image classification training processing, second round of first image classification test processing, and second round of second image classification test processing, respectively.

Moreover, the value on the right side of the hyphen in the field number column 1261 indicates the number of times (including this time) classification has been performed in each processing.

The value of the classification destination image column 1262 indicates the type of classification destination image corresponding to a target image.

The value of the display position column 1263 indicates the display position of the classification destination image corresponding to the target image.

The value of the target image column 1264 indicates the type of target image to be classified.

The value of the operation trajectory column 1265 indicates the trajectory of a touch operation of a subject detected through the client operation detection unit 14 and is represented by a string of coordinate values corresponding to a position on the screen of the client image display unit 13.

The value of the elapsed time column 1266 indicates an elapsed time (unit: second) to the classification.

The value of the correct/incorrect column 1267 indicates whether the first classification is correct or incorrect.

The client image display unit 13 is composed of a display device such as a liquid crystal panel, the client operation detection unit 14 is composed of a position input device such as a touch pad, and a touch panel is formed by a combination of these devices.

The client communication unit 15 is configured to mutually communicate with an external terminal such as a subconscious mind information management server 2 by wired communication or wireless communication according to the communication standard appropriate to long-distance wireless communication such as WiFi®.

(Subconscious Mind Information Management Server)

The subconscious mind information management server 2 includes a server control unit 21, a server storage unit 22, and a server communication unit 25. In addition, a part or the entire of the computer constituting the subconscious mind information management server 2 may be composed of a computer constituting the client 1. For example, a part or the entire of the subconscious mind information management server 2 may be composed of one or more clients 1 as a mobile station.

The server control unit 21 includes an arithmetic processing unit such as a CPU, a memory, an I/O device, and the like. The server control unit 21 may be composed of one processor or may be composed of a plurality of processors capable of communicating with each other.

The server storage unit 22 is composed of a storage device such as a ROM, a RAM, a HDD, or the like, for example. The server storage unit 22 is configured to store an arithmetic result of the server control unit 21 or data received by the server control unit 21 via the server communication unit 25.

The server storage unit 22 is configured to store an estimation result 221 received from the client 1. The estimation result 221 is able to be provided to an authenticated subject S him/herself or a third party such as a company explicitly or implicitly permitted by the subject S to access the estimation result 221.

The server communication unit 25 is composed of a communication device which communicates with an external terminal (for example, a client 1) when being connected to a public telecommunication network (for example, the Internet) as a network.

(Entire Subconscious Mind Estimation Processing)

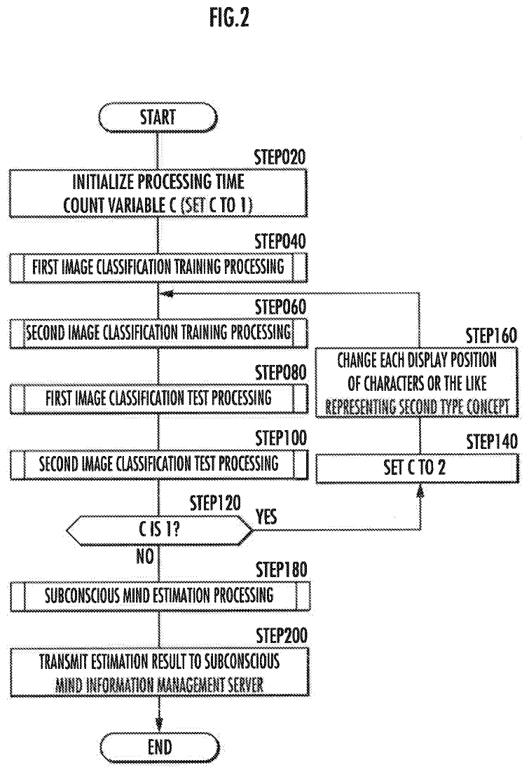

The general flow of the subconscious mind estimation processing will be described with reference to FIGS. 2 and 3.

Upon the start-up of the subconscious mind estimation program, the client control unit 11 initializes a processing time count variable C (C is set to 1) (STEP 020 of FIG. 2).

The image display control unit 111 and the operation trajectory recognition unit 112 perform first image classification training processing (STEP 040 of FIG. 2) for the second classification destination images (first type concepts) 122 in order to let the subject S classify the target image (first type concept) 124 into one of the second classification destination images (first type concepts) 122 by a predetermined number of times. The first type concepts may be preset concepts or may be concepts on a theme selected by the subject S.

The outline of the first image classification training processing will now be described. For example, as illustrated in FIG. 3A, the image display control unit 111 displays the “myself” image 1221 and the “another person” image 1222 as second classification destination images (first type concepts) 122 in the upper part of the screen of the client image display unit 13 and displays the subject name image 1241 as a target image (first type concept) 124 in the lower part of the screen.

Note here that the target image (first type concept) 124 is not limited to the subject name image 1241, but may be any image as long as the image includes characters or the like classified into one of the first type concepts “myself” and “another person” such as, for example, a person name different from the subject name, the name of a university or college to which the subject belongs, or the name of a university or college to which the subject does not belong or the like.

The operation trajectory recognition unit 112 measures the time between when the target image (first type concept) 124 is displayed and when the “myself” image 1221 or the “another person” image 1222 is selected.

The operation trajectory recognition unit 112 recognizes the operation trajectory of touch operations of the subject on the client operation detection unit 14 during the time between when the touch operation is performed on the subject name image 1241 and when the “myself” image 1221 or the “another person” image 1222 is selected.

The image display control unit 111 and the operation trajectory recognition unit 112 recognize the response time and the operation trajectory with respect to each of the target images (first type concepts) 124 by repeating the above processing for a predetermined number of target images (first type concepts) 124 almost all of which are different from each other.

The details of the first image classification training processing will be described later.

The image display control unit 111 and the operation trajectory recognition unit 112 perform the second image classification training processing (STEP 060 of FIG. 2) for the second classification destination images (second type concepts) 123 in order to let the subject S classify the target image (second type concept) 125 into one of the second classification destination images (second type concepts) 123 by a predetermined number of times. The second type concepts may be preset concepts or may be concepts on the theme selected by the subject S.

In STEP 060 of FIG. 2, the image display control unit 111 displays the “extrovert” image 1231 and the “introvert” image 1232 as the second classification destination images (second type concepts) 123 in the upper part of the screen of the client image display unit 13 and displays the “modest” image 1251 as the target image (second type concept) 125 in the lower part of the screen as illustrated in FIG. 3B.

Note that the target image (second type concept) 125 is not limited to the “modest” image 1251, but may be any image as long as the image includes characters or the like classified into one of the second type concepts “extrovert” and “introvert” such as, for example, “talkative,” “sociable,” “diffident,” “reserved,” or the like.

In the second image classification training processing in STEP 060 of FIG. 2, the classification destination images and the target image displayed on the client image display unit 13 are different from those of the first image classification training processing in STEP 040 of FIG. 2, but other processes are the same as those of the first image classification training processing in STEP 040 of FIG. 2.

The image display control unit 111 and the operation trajectory recognition unit 112 perform the first image classification test processing (STEP 080 of FIG. 2) for the first classification destination images 121 in order to let the subject S classify the target image (first type concept) 124 or the target image (second type concept) 125 into one of the first classification destination images 121 by a predetermined number of times.

In STEP 080 of FIG. 2, as illustrated in FIG. 3C, the image display control unit 111 displays the “myself”-“extrovert” image 1211 and the “another person”-“introvert” image 1212 as the first classification destination images 121 in the upper part of the screen of the client image display unit 13 and displays the target image (first type concept) 124 or the target image (second type concept) 125 (in FIG. 3C, the “modest” image 1251 as the target image [second type concept] 125) in the lower part of the screen.

In the first image classification test processing in STEP 080 of FIG. 2, the classification destination images and the target image displayed by the image display control unit 111 are different from those of the first image classification training processing in STEP 040 of FIG. 2, but other processes are the same as those of the first image classification training processing in STEP 040 of FIG. 2.

The image display control unit 111 and the operation trajectory recognition unit 112 perform the second image classification test processing (STEP 100 of FIG. 2) for the first classification destination images 121 in order to let the subject S classify the target image (first type concept) 124 or the target image (second type concept) 125 into one of the first classification destination images 121 by a predetermined number of times.

The contents of the second image classification test processing in STEP 100 of FIG. 2 are the same as those of the first image classification test processing in STEP 080 of FIG. 2.

The client control unit 11 determines whether or not the processing time count variable C is 1 (STEP 120 of FIG. 2).

If the determination result is affirmative (YES in STEP 120 of FIG. 2), the client control unit 11 sets the processing time count variable C to 2 (STEP 140 of FIG. 2), the image display control unit 111 changes each display position of the characters or the like representing the second type concept (STEP 160 of FIG. 2), and then the processes of STEP 060 of FIG. 2 to STEP 100 of FIG. 2 are performed again.

In STEP 060 of FIG. 2 at the second time, as illustrated in FIG. 3D, the image display control unit 111 exchanges the display positions of the “introvert” image 1232 and the “extrovert” image 1231 as the second classification destination images (second type concepts) 123 when displaying the images. The image display control unit 111 displays the second target image (second type concept) 125 in the lower part of the screen.

In STEPS 080 to 100 of FIG. 2 at the second time, as illustrated in FIG. 3E, the image display control unit 111 changes the way of combination of the first type concept and the second type concept and then displays the “myself”-“introvert” image 1213 and the “another person”-“extrovert” image 1214 obtained by exchanging the display positions of characters “introvert” and “extrovert” corresponding to the second type concepts. The image display control unit 111 displays the target image (first type concept) 124 or the target image (second type concept) 125 in the lower part of the screen.

If the determination result of STEP 120 of FIG. 2 is negative (NO in STEP 120 of FIG. 2), the subconscious mind estimation unit 113 performs subconscious mind estimation processing described later (STEP 180 of FIG. 2) on the basis of each recognized response time and operation trajectory. In addition, STEP 180 of FIG. 2 corresponds to the “subconscious mind estimation step” of the present invention.

The subconscious mind estimation unit 113 transmits an estimation result, which is an evaluation value of a tie between each of the first type concepts and each of the second type concepts of the subject obtained in the subconscious mind estimation processing, to the subconscious mind information management server 2 via the client communication unit 15 (STEP 200 of FIG. 2). In addition to or instead of the above, the subconscious mind estimation unit 113 may display the estimation result on the image display unit 13.

(Image Classification Training Processing and Image Classification Test Processing)

Subsequently, referring to FIGS. 3 to 5, the following describes the first and second image classification training processing in STEP 040 of FIG. 2 and STEP 060 of FIG. 2 and the first and second image classification test processing in STEP 080 of FIG. 2 and STEP 100 of FIG. 2. These processes are the same as each other except that the images displayed on the client image display unit 13 are different from each other.

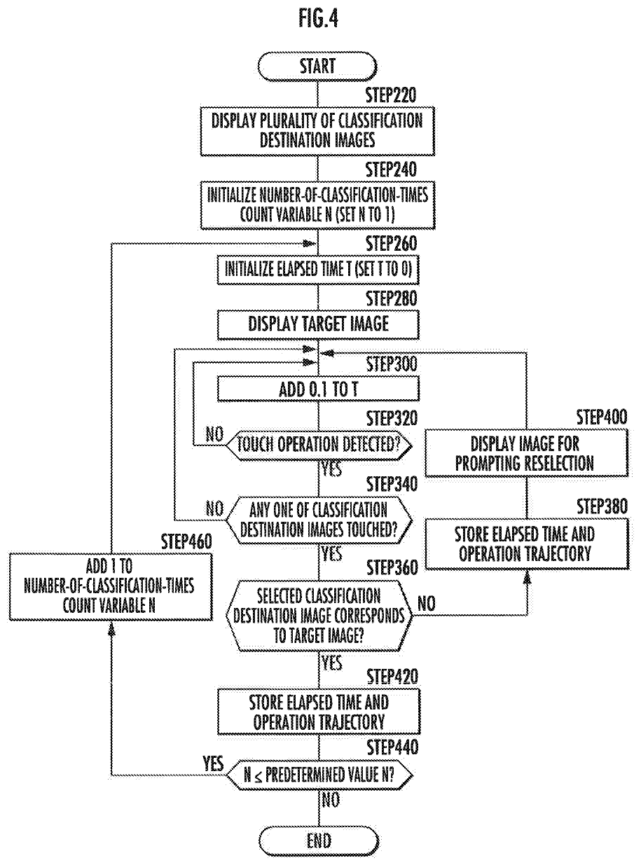

The image display control unit 111 displays a plurality of (two in this embodiment) classification destination images on the client image display unit 13 (STEP 220 of FIG. 4). In addition, STEP 220 of FIG. 4 corresponds to the “first classification destination image display step” of the present invention.

For example, in the first image classification training processing in STEP 040 of FIG. 2, the image display control unit 111 reads the second classification destination images (first type concepts) 122 stored in the client storage unit 12 and, as illustrated in FIG. 3A, displays the second classification destination images (first type concepts) 122 (the “myself” image 1221 and the “another person” image 1222) in the upper part of the screen of the client image display unit 13;

Note that, if the screen of the client image display unit 13 is divided into three equal parts by an upper dividing line UL and a lower dividing line DL in the vertical direction, the image display control unit 111 displays the “myself” image 1221 and the “another person” image 1222 on the client image display unit 13 so that the centers of the “myself” image 1221 and the “another person” image 1222 are located upper than the upper dividing line UL.

Moreover, if the screen of the client image display unit 13 is bisected by the central dividing line CL in the horizontal direction, the image display control unit 111 displays the “myself” image 1221 and the “another person” image 1222 on the client image display unit 13 so that the centers of the “myself” image 1221 and the “another person” image 1222 are line-symmetric with respect to the central dividing line CL.

Furthermore, in the second image classification training processing in STEP 060 of FIG. 2, the image display control unit 111 reads the second classification destination images (second type concepts) 123 stored in the client storage unit 12 and, as illustrated in FIG. 3B, displays the second classification destination images (second type concepts) 123 (the “extrovert” image 1231 and the “introvert” image 1232 in FIG. 3B) in the upper part of the screen of the client image display unit 13.

Moreover, in the first or second image classification test processing in STEP 080 of FIG. 2 or STEP 100 of FIG. 2, the image display control unit 111 reads the first classification destination images 121 stored in the client storage unit 12 and, as illustrated in FIG. 3C, displays the first classification destination images 121 (the “myself”-“extrovert” image 1211 and the “another person”-“introvert” image 1212 in FIG. 3C) in the upper part of the screen of the client image display unit 13.

The image display control unit 111 initializes the number-of-classification-times count variable n (sets n to 1) (STEP 240 of FIG. 4).

The operation trajectory recognition unit 112 initializes an elapsed time t (sets t to 0) (STEP 260 of FIG. 4).

The image display control unit 111 displays one target image corresponding to the concept represented by characters or the like included in the classification destination image in the lower part of the screen of the client image display unit 13 (STEP 280 of FIG. 4). Although preferably displaying target images randomly on the client image display unit 13, more preferably the image display control unit 111 displays target images different from each other randomly on the client image display unit 13.

For example, in the first image classification training processing in STEP 040 of FIG. 2, the image display control unit 111 reads a target image (first type concept) 124 which is the target image corresponding to the first type concept from the client storage unit 12 and, as illustrated in FIG. 3A, displays the target image (first type concept) 124 (the subject name image 1241 in FIG. 3A) in the lower part of the screen of the client image display unit 13.

Note that, if the screen of the client image display unit 13 is divided into three equal parts by the upper dividing line UL and the lower dividing line DL in the vertical direction, the image display control unit 111 displays the subject name image 1241 as the target image on the client image display unit 13 so that the center of the target image is located lower than the lower dividing line DL.

Moreover, if the screen of the client image display unit 13 is bisected by the central dividing line CL in the horizontal direction, the image display control unit 111 displays the subject name image 1241 as a target image on the client image display unit 13 so that the center of the target image is located on the central dividing line CL.

Furthermore, in the second image classification training processing in STEP 060 of FIG. 2, the image display control unit 111 reads a target image (second type concept) 125 which is the target image corresponding to the second type concept from the client storage unit 12 and, as illustrated in FIG. 3B, displays the target image (second type concept) 125 (the “modest” image 1251 in FIG. 3B) in the lower part of the screen of the client image display unit 13.

The target image displayed in the first image classification training processing in STEP 040 of FIG. 2 or the second image classification training processing in STEP 060 of FIG. 2 corresponds to the “second target image” of the present invention.

Moreover, in the first or second image classification test processing in STEP 080 of FIG. 2 or STEP 100 of FIG. 2, the image display control unit 111 reads the target image (first type concept) 124 corresponding to the first type concept or the target image (second type concept) 125 corresponding to the second type concept from the client storage unit 12 and, as illustrated in FIG. 3C, displays the target image (the “modest” image 1251 as the target image [second type concept] 125 in FIG. 3C) in the lower part of the screen of the client image display unit 13.

The target image displayed in the first image classification test processing in STEP 080 of FIG. 2 or the second image classification test processing in STEP 100 of FIG. 2 corresponds to the “first target image” of the present invention.

In addition, STEP 280 of FIG. 4 corresponds to the “first target image display step” of the present invention.

The operation trajectory recognition unit 112 adds 0.1 to the elapsed time t (STEP 300 of FIG. 4).

It is determined whether or not the operation trajectory recognition unit 112 recognized a touch operation Oₜ(i, j) on the client operation detection unit 14 (STEP 320 of FIG. 4).

Although the touch operation Oₜ(i, j) may be any type of operation, preferably the touch operation is a swipe operation with the position where the target image is displayed as a starting point. Instead, the touch operation may be a swipe operation with the position where the classification destination image is displayed as a starting point.

The touch operation Oₜ(i, j) is represented by coordinate values corresponding to the position on the screen of the client image display unit 13 detected by the client operation detection unit 14.

Note that i is a numerical value ranging from 1 to 7 indicating each processing and j is a value indicating the number of times (including this time) classification has been performed in each processing.

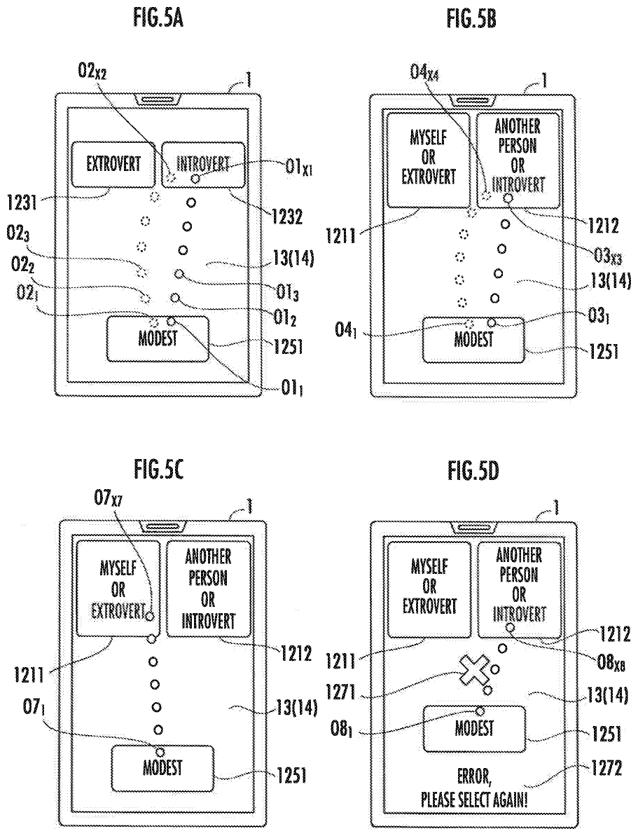

For example, as illustrated in FIG. 5A, the operation trajectory recognition unit 112 recognizes a touch operation O1ₜ(i, j) (or a touch operation O2ₜ(i, j)) detected by the client operation detection unit 14.

If the determination result is negative (NO in STEP 320 of FIG. 4), the operation trajectory recognition unit 112 performs the following processing in STEP 300 of FIG. 4 again.

If the determination result is affirmative (YES in STEP 320 of FIG. 4), the operation trajectory recognition unit 112 determines whether or not a touch operation on any one of the classification destination images has been detected (STEP 340 of FIG. 4).

For example, the operation trajectory recognition unit 112 determines whether or not the coordinate values indicated with respect to the detected touch operation Oₜ(i, j) are present within a predetermined range indicating one of the classification destination images.

If the determination result is negative (NO in STEP 340 of FIG. 4), the operation trajectory recognition unit 112 performs the following processing in STEP 300 of FIG. 4 again.

If the determination result is affirmative (YES in STEP 340 of FIG. 4), the operation trajectory recognition unit 112 determines whether or not the selected classification destination image corresponds to the target image by reference to information appended to the target image (STEP 360 of FIG. 4).

If the determination result is negative (NO in STEP 360 of FIG. 4), the operation trajectory recognition unit 112 stores the response time and the operation trajectory (STEP 380 of FIG. 4).

More specifically, the operation trajectory recognition unit 112 creates a field in which the value of the field number column 1261 is “i-j,” the value of the classification destination image column 1262 is a classification destination image selected by a subject among the currently displayed classification destination images, the value of the display position column 1263 is a position (“left” or “right”) where the classification destination image is displayed, the value of the target image column 1264 is a currently displayed target image, the value of the operation trajectory column 1265 is a string of touch operations Oₜ(i, j) (t=0.1, . . . ) detected until the process of STEP 380 of FIG. 4, the value of the elapsed time column 1266 is an elapsed time t, and the value of the correct/incorrect column 1267 is “I” (Incorrect), adds the field to the operation information 126, and then stores the field in the client storage unit 12.

In addition, it is possible to use the time from the target image display to the classification destination image display, which has been measured by using the time measurement function of a timer or the like, instead of the elapsed time t.

For example, the operation trajectory recognition unit 112 stores the string of the coordinate values indicating the touch operations O1ₜ(i, j) (t=0.1, . . . , x1) illustrated in FIG. 5A in the operation trajectory column.

The image display control unit 111 causes the client image display unit 13 to display an image for prompting reselection (STEP 400 of FIG. 4).

More specifically, as illustrated in FIG. 3F, the image display control unit 111 causes the client image display unit 13 to display an image 1271 for informing the subject of an incorrect operation and an image 1272 including a message for prompting reselection while continuously displaying the classification destination images and the target image.

After STEP 400 of FIG. 4, the operation trajectory recognition unit 112 performs the processes of STEPS 300 to 360 of FIG. 4.

If the determination result of STEP 360 of FIG. 4 is affirmative, (YES in STEP 360 of FIG. 4), the operation trajectory recognition unit 112 stores the elapsed time t and the operation trajectory in the client storage unit 12 (STEP 420 of FIG. 4).

More specifically, the operation trajectory recognition unit 112 creates a field in which the value of the field number column 1261 is a character string corresponding to the process under execution, the value of the classification destination image column 1262 is a classification destination image selected by a subject among the currently displayed classification destination images, the value of the display position column 1263 is a position (“left” or “right”) where the classification destination image is displayed, the value of the target image column 1264 is a currently displayed target image, the value of the operation trajectory column 1265 is a string of user operations Oₜ(i, j) (t=0.1, . . . ) detected until STEP 360 of FIG. 4, the value of the elapsed time column 1266 is an elapsed time t, and the value of the correct/incorrect column 1267 is “C” (Correct), adds the field to the operation information 126, and then stores the field in the client storage unit 12.

In addition, it is possible to use the time from the target image display to the classification destination image display, which has been measured by using the time measurement function of a timer or the like, instead of the elapsed time t.

STEPS 320, 340, 360, 380, and 420 of FIG. 4 correspond to the “classification processing step” of the present invention.

In the case where the elapsed time and the operation trajectory are stored in STEP 380 of FIG. 4, the operation trajectory recognition unit 112 may omit the process of STEP 420 of FIG. 4.

The image display control unit 111 determines whether or not the number-of-classification-times count variable n is equal to or lower than a predetermined value N (STEP 440 of FIG. 4).

If the determination result is affirmative (YES in STEP 440 of FIG. 4), the image display control unit 111 adds one to the number-of-classification-times count variable n (STEP 460 of FIG. 4) and the image display control unit 111 and the operation trajectory recognition unit 112 perform the processes of STEP 260 and subsequent steps.

If the determination result is negative (NO in STEP 440 of FIG. 4), the image display control unit 111 ends this processing.

(Subconscious Mind Estimation Processing)

Referring to FIGS. 5 to 7, the subconscious mind estimation processing in STEP 180 of FIG. 2 will be described.

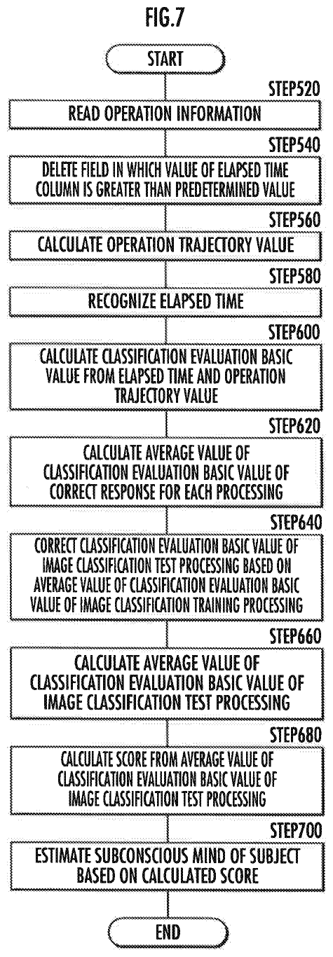

The subconscious mind estimation unit 113 reads the operation information 126 from the client storage unit 12 (STEP 520 of FIG. 7).

The subconscious mind estimation unit 113 deletes a field in which the value of the elapsed time column 1266 among the operation information 126 is greater than a predetermined value (STEP 540 of FIG. 7). For example, if the predetermined value is 10 in FIG. 6, the subconscious mind estimation unit 113 deletes the field of No. 7-1 in which the value of the elapsed time column 1266 is greater than 10.

The subconscious mind estimation unit 113 calculates an operation trajectory value OT(i, j), which is an evaluation value of the operation trajectory, from the value of the operation trajectory column 1265 among the operation information 126 (STEP 560 of FIG. 7). The operation trajectory value OT(i, j) intermittently or continuously takes a greater value in the case where it is presumed that the subject S hesitated on the basis of the operation trajectory and intermittently or continuously takes a smaller value in the case where it is presumed that the subject S did not hesitate on the basis of the operation trajectory.

The values of the operation trajectory column 1265 in the first image classification training processing and the second image classification training processing correspond to the “second operation trajectory” and the “predetermined operation trajectory” of the present invention, and the values of the operation trajectory column 1265 in the first image classification test processing and the second image classification test processing correspond to the “first operation trajectory” of the present invention.

Note that i is a value on the left side of the hyphen of the field number column 1261 and j is a value on the right side of the hyphen of the field number column 1261.

As the operation trajectory values, it is possible to adopt a total travel distance in the operation trajectory, a divergence from a straight line between a target image and a classification destination image, the number of changes in direction of the operation trajectory, an amount of time during which a finger stays in a certain position, an average travel speed, an average acceleration, or the like, for example.

The total travel distance L₁(i, j) in the operation trajectory can be obtained by the following equation (1), for example.

[Math. 1]

L₁(i,j)=Σ∥Oₜ(i,j)−Oₜ₋₁(i,j)∥ (1)

In the above, ∥vector∥ means the norm of a vector.

In addition, preferably when the total travel distance L₁(i, j) is longer, the operation trajectory value OT(i, j) is intermittently or continuously set to a greater value, and when the total travel distance L₁(i, j) is shorter, the operation trajectory value OT(i, j) is intermittently or continuously set to a smaller value, for example, by using the total travel distance L1(i, j) as the operation trajectory value OT(i, j) or the like.

The divergence ρ(i, j) from the straight line between the target image and the classification destination image can be obtained by the following equation (2), assuming that L₂ is the distance of the straight line between the target image and the classification destination image, for example.

$$[ Math . 2 ]$$

$$ρ ( i , j ) = \frac{{L}_{1} ( i , j )}{{L}_{2}} \qquad ( 2 )$$

Preferably when the divergence ρ(i, j) is greater, the operation trajectory value OT(i, j) is intermittently or continuously set to a greater value, and when the divergence ρ(i, j) is smaller, the operation trajectory value OT(i, j) is intermittently or continuously set to a smaller value, for example, by using the divergence ρ(i, j) as the operation trajectory value OT(i, j) or the like.

Moreover, it is determined that a change in direction has occurred if the inner product between a vector Oₜ₋₁(i, j)-Oₜ₋₂(i, j) indicating the trajectory of a touch operation between time t-2 to time t-1 and a vector Oₜ(i, j)-Oₜ₋₁(i, j) indicating the trajectory of a touch operation between time t-1 to time t is equal to or lower than a predetermined value, and the number of changes in direction on the operation trajectory can be calculated by finding the number of times a change in direction is determined to occur. Preferably when the number of changes in direction is greater, the operation trajectory value OT(i, j) is intermittently or continuously set to a greater value, and when the number of changes in direction is smaller, the operation trajectory value OT(i, j) is intermittently or continuously set to a smaller value, for example, by using the number of changes in direction as the operation trajectory value OT(i, j) or the like.

Moreover, it is determined that a finger has stayed in a certain position if the norm of the vector Oₜ(i, j)-Oₜ₋₁(i, j) indicating the trajectory of the touch operation between time t-1 to time t is equal to or greater than a predetermined value, and an amount of time during which a finger stays in a certain position can be obtained by counting the number of times the finger stays in the certain position. Preferably when the time during which the finger stays in a certain position is longer, the operation trajectory value OT(i, j) is intermittently or continuously set to a greater value, and when the time during which the finger stays in a certain position is shorter, the operation trajectory value OT(i, j) is intermittently or continuously set to a smaller value, for example, by using the time during which the finger stays in a certain position as the operation trajectory value OT(i, j) or the like.

The average travel speed can be obtained from an average value of the norm of the vector Oₜ(i, j)-Oₜ₋₁(i, j) indicating the trajectory of the touch operation between time t-1 to time t. Preferably when the average travel speed is lower, the operation trajectory value OT(i, j) is intermittently or continuously set to a greater value, and when the average travel speed is higher, the operation trajectory value OT(i, j) is intermittently or continuously set to a smaller value, for example, by using a value obtained by subtracting the average travel speed from a predetermined speed as the operation trajectory value OT(i, j) or the like.

The average acceleration can be obtained as a variation of an average travel speed. Preferably, when the average acceleration is lower, the operation trajectory value OT(i, j) is intermittently or continuously set to a greater value, and when the average acceleration is higher, the operation trajectory value OT(i, j) is intermittently or continuously set to a smaller value, for example, by using a value obtained by subtracting the average acceleration from a predetermined acceleration as the operation trajectory value OT(i, j) or the like.

The subconscious mind estimation unit 113 recognizes the value of the elapsed time column 1266 among the operation information 126 as an elapsed time ET(i, j) (STEP 580 of FIG. 7).

The subconscious mind estimation unit 113 calculates a classification evaluation basic value V(i, j) by using the following equation (3) on the basis of the elapsed time ET(i, j) and the operation trajectory value OT(i, j) among the operation information 126 (STEP 600 of FIG. 7).

[Math. 3]

V(i,j)=ƒ(ET(i,j),OT(i,j)) (3)

Character ƒ indicates a function which increases intermittently or continuously as one or both of the elapsed time ET(i, j) and the operation trajectory value OT(i, j) increase.

For example, f is expressed by the following equation (4).

[Math. 4]

ƒ(ET(i,j),OT(i,j))=ET(i,j)*OT(i,J) (4)

For example, when the operation trajectory value OT(i, j) is the divergence ρ(i, j) from the straight line between the target image and the classification destination image, the classification evaluation basic value V(i, j) is expressed by the following equation (5).

[Math. 5]

V(i,j)=ET(i,j)*ρ(i,j) (5)

The subconscious mind estimation unit 113 calculates an average value Vc_avg(i) of the classification evaluation basic value Vc(i, j) by the following equation (6) (STEP 620 of FIG. 7). Note that the classification evaluation basic value Vc(i, j) is a classification evaluation basic value of a field in which the value of the correct/incorrect column 1267 is “C” (Correct).

$$[ Math . 6 ]$$

$$Vc\_avg ( i ) = \frac{Σ Vc ( i , j )}{Jc ( i )} \qquad ( 6 )$$

Moreover, Jc(i) indicates the number of fields in which the value of the correct/incorrect column 1267 included in each process i is “C” (Correct).

The subconscious mind estimation unit 113 corrects the classification evaluation basic value V(i, j) (i=3, 4, 6, 7) of the image classification test processing on the basis of the average value Vc_avg(i) (i=1, 2, 5) of the classification evaluation basic value of the second image classification training processing and calculates the classification evaluation basic value Vamended(i, j) (i=3, 4, 6, 7) after the correction (STEP 640 of FIG. 7).

More specifically, the subconscious mind estimation unit 113 corrects the classification evaluation basic value Vc(i, j) (i=3, 4, 6, 7) of the image classification test processing by using the average value Vc(i)(i=1, 2, 5) of the classification evaluation basic value of the second image classification training processing corresponding to each image classification test processing by using the following equations (7) and (8).

Note that Jc(1) indicates the number of fields in which the value of the correct/incorrect column 1267 is “C” (Correct) in the first image classification training, Jc(2) indicates the number of fields in which the value of the correct/incorrect column 1267 is “C” (Correct) in the first round of the second image classification training, and Jc(5) indicates the number of fields in which the value of the correct/incorrect column 1267 is “C” (Correct) in the second round of the second image classification training. Instead of Jc(1), Jc(2), and Jc(5), coefficients for use in adjusting ratios may be used, such that the number of times the target image (first type concept) is displayed may be used instead of Jc(1) in the target image classification test processing (i=3, 4, 6, 7), the number of times the target image (second type concept) is displayed may be used instead of Jc(2) in the target image classification test processing (i=3, 4), the number of times the target image (second type concept) is displayed may be used instead of Jc(5) in the target image classification test processing (i=6, 7), or the like.

$$[ Math . 7 ]$$

$$\begin{matrix}{V}_{amended} ( i , j ) = Vc ( i , j ) - \frac{( Vc\_avg ( 1 ) * Jc ( 1 ) + Vc\_avg ( 2 ) * Jc ( 2 ) )}{Jc ( 1 ) + Jc ( 2 )} ( i = 3 , 4 ) \\ [ Math . 8 ] & ( 7 ) \\ {V}_{amended} ( i , j ) = Vc ( i , j ) - \frac{( Vc\_avg ( 1 ) * Jc ( 1 ) + Vc\_avg ( 5 ) * Jc ( 5 ) )}{Jc ( 1 ) + Jc ( 5 )} ( i = 6 , 7 ) & ( 8 )\end{matrix}$$

In addition, Vamended(i, j) corresponds to “the divergence between the first operation trajectory and the predetermined operation trajectory” of the present invention.

Furthermore, the subconscious mind estimation unit 113 corrects the classification evaluation basic value Vuc(i, j) (i=3, 4, 6, 7) of the image classification test processing by using the average value Vc(i)(i=2, 5) of the classification evaluation basic value of the second image classification training processing corresponding to each image classification test processing by the following equations (9) and (10). Note that Vuc(i, j) is a classification evaluation basic value of a field in which the value of the correct/incorrect column 1267 is “I” (Incorrect). In addition, “Penalty” is a positive predetermined value.

[Math. 9]

V_{amended}(i,j)=Penalty−(Vc(i,j)−Vc_avg(2))(i=3,4) (9)

[Math. 10]

V_{amended}(i,j)=Penalty−(Vc(i,j)−Vc_avg(5)(i=6,7)) (10)

The subconscious mind estimation unit 113 calculates an average value Vam_avg(i) of the classification evaluation basic value Vamended(i, j) after the correction by using the following equation (11) for each image classification test processing (STEP 660 of FIG. 7). Note here that J(i) indicates the number of classification times for each image classification test processing.

$$[ Math . 11 ]$$

$$Vam\_avg ( i ) = \frac{Σ Vamended ( i , j )}{J ( i )} \qquad ( 11 )$$

The subconscious mind estimation unit 113 calculates the score “score” on the basis of the average value Vam_avg(i) of the classification evaluation basic value (STEP 680 of FIG. 7).

For example, the subconscious mind estimation unit 113 calculates the score “score” by using the following equation (12).

[Math. 12]

score=Vam_avg(3)+Vam_avg(4)−Vam_avg(6)−Vam_avg(7) (12)

The subconscious mind estimation unit 113 estimates the strength of the tie between each first type concept and each second type concept of the subject S on the basis of the calculated score “score” (STEP 700 of FIG. 7).

For example, if the score “score” is zero or a value close to zero (if the absolute value is equal to or smaller than a predetermined value), the subconscious mind estimation unit 113 determines stepwise or continuous values (for example, 4 to 6) which indicate that the subject S does not feel a special tie with respect to the strength of the tie between each first type concept and each second type concept of the subject S, as an estimation result.

Moreover, if the absolute value of the score “score” is a minus value equal to or greater than the predetermined value, the subconscious mind estimation unit 113 determines stepwise or continuous values (for example, 7 to 9) which indicate a strong tie in combination of each first type concept and each second type concept in the first round of image classification test processing, with respect to the strength of the tie between each first type concept and each second type concept of the subject, as an estimation result.

More specifically, if the combination of each first type concept and each second type concept illustrated in FIG. 3C is implemented as the first round of image classification test processing and if the score “score” is minus, the subconscious mind estimation unit 113 determines values which indicate a strong tie between the first type concept “myself” and the second type concept “extrovert” and a strong tie between the first type concept “another person” and the second type concept “introvert,” as an estimation result.

If the absolute value of the score “score” is a plus value equal to or greater than the predetermined value, the subconscious mind estimation unit 113 determines stepwise or continuous values (for example, 1 to 3) which indicate a strong tie in combination of each first type concept and each second type concept in the second round of image classification test processing, with respect to the strength of the tie between each first type concept and each second type concept of the subject, as an estimation result.

More specifically, if the combination of each first type concept and each second type concept illustrated in FIG. 3E is implemented as the second round of image classification test processing and if the score “score” is plus, the subconscious mind estimation unit 113 determines values which indicate a strong tie between the first type concept “myself” and the second type concept “introvert” and a strong tie between the first type concept “another person” and the second type concept “extrovert,” as an estimation result.

Additionally, the smaller the correction value Vamended(i, j) (corresponding to “the divergence between the first operation trajectory and the predetermined operation trajectory” of the present invention) of the classification evaluation basic value is, the smaller the average value Vam_avg(i) of the classification evaluation basic value is. Furthermore, if i=3 or 4 (if the correction value Vamended(i, j) of the classification evaluation basic value in the first round of image classification test processing is small), the score “score” is low. In this case, it is estimated that the subject S has a subconscious mind that the combination of each first type concept and each second type concept displayed on the client image display unit 13 (corresponding to the “image display unit” of the present invention) has a strong tie in the first round of image classification test processing.

Furthermore, the smaller the correction value Vamended(i, j) of the classification evaluation basic value is, the smaller the average value Vam_avg(i) of the classification evaluation basic value is. Furthermore, if i=6 or 7, in other words, if the correction value Vamended(i, j) of the classification evaluation basic value in the second round of image classification test processing is small, the score “score” is high. In this case, it is estimated that the subject S has a subconscious mind that the combination of each first type concept and each second type concept displayed on the client image display unit 13 has a strong tie in the second round of image classification test processing.

In the present invention, the expression “to estimate the subconscious mind of the subject about the tie between the first type concept and the second type concept on the basis of the touch operations of the subject” means estimating the subconscious mind of the subject S about the tie between the first type concept and the second type concept on the basis of information acquired at a touch operation of the subject such as the elapsed time ET(i, j) or the operation trajectory OT(i, j).

Moreover, in the present invention, the expression “to estimate the subconscious mind of the subject about the tie between the first type concept and the second type concept on the basis of the operation trajectory of the subject” means estimating the subconscious mind of the subject S about the tie between the first type concept and the second type concept on the basis of the operation trajectory OT(i, j).

### Operation and Effect of the Embodiment

Subsequently, the operation and effect of the embodiment will be described with reference to FIGS. 3 and 5.

In the first image classification training processing illustrated in FIG. 3A or the second image classification training processing illustrated in FIG. 3B or 3D, there is only one concept represented by characters or the like included in the classification destination image and therefore it is considered that the subject S is able to select the classification destination image without much hesitation.

On the other hand, in the first or second image classification test processing illustrated in FIG. 3C or 3E, there are a plurality of concepts represented by characters or the like included in the classification destination image, and therefore the subject S is able to give a response without hesitation in the case where the combination of the displayed concepts does not diverge from the subconscious mind of the subject S, while the subject S is likely to hesitate to select the classification destination image in the case where the combination of the displayed concepts diverges from the subconscious mind of the subject S.

If the subject S hesitates, the hesitation is thought to be reflected on the operation trajectory of the subject S.

More specifically, for example, if the subject S does not hesitate so much, it is highly probable that a touch operation O1t (t=0.1, . . . , x1) draws a certain trajectory such as, for example, a substantially linear trajectory as illustrated in FIG. 5A.

Moreover, if a combination of characters or the like representing a plurality of concepts matches the subconscious mind of the subject S even in the case where the combination is included in the classification destination image, it is highly probable that a touch operation O3t (t=0.1, . . . , x3) draws a certain trajectory such as, for example, a substantially linear trajectory as illustrated in FIG. 5B.

On the other hand, if the combination does not match the subconscious mind of the subject S, it is highly probable that the subject S hesitates in selecting the classification destination image and a touch operation O4t (t=0.1, . . . , x4) diverges from a certain trajectory as illustrated in FIG. 5B.

In this manner, the operation trajectory is useful information for estimating the subconscious mind of the subject S about the tie between each first type concept and each second type concept.

According to the subconscious mind estimation system of this embodiment configured focusing on this matter, the subconscious mind of the subject S about the tie between each first type concept and each second type concept is estimated by using the values of the operation trajectory column 1265 included in the operation information 126 (STEPS 520, 600, 680, and 700 of FIG. 7). Thereby, the subconscious mind of the subject S about the tie between each first type concept and each second type concept is estimated with high accuracy.

Moreover, the operation trajectory may vary with a habit of the subject S, a posture of the subject S, or the like in addition to the hesitation.

For example, even in the case where the subject S has no hesitation, the subject S might perform a touch operation O2t (t=0.1, . . . , x2) which diverges from the straight line as illustrated in FIG. 5A, for example.

In this case, even if the operation trajectory diverges from the straight line as represented by the touch operation O4t(t=0.1, . . . , x4) illustrated in FIG. 5B, it does not necessarily mean that the subject S hesitates.

According to the subconscious mind estimation system of this embodiment configured focusing on this matter, the classification evaluation basic value V(i, j) in each image classification test processing is corrected (STEP 640 of FIG. 7) by using the values of the operation trajectory column 1265 included in the operation information 126 in the first and second image classification training processing.

As a result, the subconscious mind of the subject S about the tie between each first type concept and each second type concept is estimated with high accuracy.

Moreover, if the selected classification destination image is incorrect even in the case where the operation trajectory is close to a certain trajectory (a linear trajectory or the like), it is highly probable that the subject S has a subconscious mind that the tie is weak in the combination of each first type concept and each second type concept represented by the characters or the like included in the displayed classification destination image.

More specifically, consideration will be given to a case where the subject S selects the “myself”-“extrovert” image 1211 along a certain trajectory as represented by a touch operation O7t (t=0.1, . . . , x7) in the case where the “myself”-“extrovert” image 1211, the “another person”-“introvert” image 1212, and the “modest” image 1251 are displayed as illustrated in FIG. 5C.

The “modest” image 1251 is a target image corresponding to the second type concept “introvert” and therefore the selection of the subject S is incorrect. In this kind of situation, even if the selection is made along a certain trajectory, the tie is not strong in the combination of the first type concept “myself” and the second type concept “extrovert” corresponding to the characters or the like included in the displayed “myself”-“extrovert” image 1211, and it is estimated that the tie between the first type concept “myself” and the second type concept “introvert” is rather strong.

According to the subconscious mind estimation system of this embodiment configured focusing on this matter, the correction mode in the classification evaluation basic value V(i, j) in each image classification test processing is varied according to the value of the correct/incorrect column 1267 (STEP 640 of FIG. 7).

As a result, the subconscious mind of the subject S about the tie between each first type concept and each second type concept is estimated with high accuracy.

Moreover, if the situation is after reselection is prompted as illustrated in FIG. 5D even in the case where the operation trajectory is close to a certain trajectory (a linear trajectory or the like), it is thought that the operation trajectory is less likely to reflect the subconscious mind of the subject S about the tie between each first type concept and each second type concept.

According to the subconscious mind estimation system of this embodiment configured in view of this point, the operation trajectory detected until before the display of the image for prompting reselection (STEP 380 of FIG. 4) is stored and the subconscious mind of the subject S is estimated on the basis of the operation trajectory. This enables estimation of the subconscious mind of the subject S about the tie between each first type concept and each second type concept with high accuracy.

(Modification)

In the subconscious mind estimation system of this embodiment, the client control unit 11 has functioned as the image display control unit 111, the operation trajectory recognition unit 112, and the subconscious mind estimation unit 113. The server control unit 21, however, may function as some or all of the image display control unit 111, the operation trajectory recognition unit 112, and the subconscious mind estimation unit 113, and the client 1 may communicate with the subconscious mind information management server 2 appropriately to perform the subconscious mind estimation processing.

In the subconscious mind estimation system of this embodiment, the classification evaluation basic value V(i, j) in each image classification test processing has been corrected by using the values of the operation trajectory column 1265 included in the operation information 126 in the first and second image classification training processing. The correction, however, is not limited thereto. For example, the classification evaluation basic value V(i, j) in each image classification test processing may be corrected by using the values of the operation trajectory column 1265 included in the operation information 126 in the second image classification training processing, or the classification evaluation basic value V(i, j) in each image classification test processing may be corrected by using the values of the operation trajectory column 1265 included in the operation information 126 in the first image classification training processing.

Furthermore, the processes of STEPS 620 and 640 of FIG. 7 may be omitted.

In this embodiment, the score “score” has been calculated by using the equation (12). Instead thereof, however, for example, as described in Patent Document 1, the score “score” may be calculated by the following equation (13) by using a variance σ1 of the classification evaluation basic value V(i, j) in the first image classification test processing and a variance σ2 of the classification evaluation basic value V(i, j) in the second image classification test processing.

$$[ Math . 13 ]$$

$$score = \frac{Vam\_avg ( 3 ) - Vam\_avg ( 6 )}{σ 1} + \frac{Vam\_avg ( 4 ) - Vam\_avg ( 7 )}{σ2} \qquad ( 13 )$$

In this embodiment, the classification evaluation basic value V(i, j) has been calculated by using the values of the operation trajectory column 1265 and the value of the elapsed time column 1266. The classification evaluation basic value V(i, j), however, may be calculated by using the values of the operation trajectory column 1265 without using the value of the elapsed time column 1266.

In this embodiment, the score “score” has been calculated including the fields where the value of the correct/incorrect column 1267 is “I” (Incorrect). The score “score,” however, may be calculated by using only the values of the fields where the value of the correct/incorrect column 1267 is “C” (Correct).

In the subconscious mind estimation system of this embodiment, the classification evaluation basic value V(i, j) has been calculated by using the elapsed time ET(i, j) and the operation trajectory OT(i, j). Instead, however, the elapsed time ET(i, j) may be used as the classification evaluation basic value V(i, j), the operation trajectory value OT(i, j) may be used as the classification evaluation basic value V(i, j), or the classification evaluation basic value V(i, j) may be calculated by using one or both of the elapsed time ET(i, j) and the operation trajectory value OT(i, j) and other values.

In the subconscious mind estimation system of this embodiment, one or both of the first image classification training processing and the second image classification training processing may be omitted. Moreover, the second image classification test processing may be omitted and the test processing may be added.

Furthermore, the classification has been performed the same number of times in each image classification training processing and each image classification test processing. Instead, however, the number of classification times may be varied for each processing such that the classification is performed a greater number of times in the test processing, for example.

### DESCRIPTION OF REFERENCE NUMERALS

13 Client image display unit
14 Client operation detection unit
111 Image display control unit
112 Operation trajectory recognition unit
113 Subconscious mind estimation unit
1211 First classification destination image
1212 First classification destination image
1213 First classification destination image
1214 First classification destination image
1241 First target image
1251 First target image
S Subject
Oₜ Touch operation

1. A subconscious mind estimation system comprising:
an image display unit which displays an image;
an operation detection unit which is formed integrally with the image display unit and is able to detect a touch operation of a subject;
a classification processing unit which displays M first classification destination images (M is an integer satisfying M≥2, M≤K, and M≤L), which are still images or moving images each including a combination of at least one of characters, a symbol, a numeral, a figure, an object image, a pattern, and a color representing each of K first type concepts (K is an integer satisfying K≥2) and at least one of characters, a symbol, a numeral, a figure, an object image, a pattern, and a color representing each of L second type concepts (L is an integer satisfying L≥2) different from each of the first type concepts, and a first target image, which is a still image or a moving image including at least one of characters, a symbol, a numeral, a figure, an object image, a pattern, and a color corresponding to any one of the K first type concepts and the L second type concepts on the image display unit, and then continues to display the first target image on the image display unit until detecting that at least both of a touch operation of the subject on the first target image and a touch operation of the subject on one of the first classification destination images are performed via the operation detection unit; and
a subconscious mind estimation unit which estimates a subconscious mind of the subject about a tie between the first type concept and the second type concept based on the touch operations of the subject detected by the classification processing unit.

2. The subconscious mind estimation system according to claim 1, wherein, in the case where the display screen of the image display unit is divided into three equal parts including an upper part, a center part, and a lower part of the display screen, the classification processing unit displays the M first classification destination images and the first target image on the image display unit so that all of the center positions of the M first classification destination images are included in the upper part and the center position of the first target image is included in the lower part.

3. The subconscious mind estimation system according to claim 1, wherein:
the classification processing unit is configured to recognize a first operation trajectory, which is a trajectory of touch operations of the subject obtained until both of the touch operation on the first target image and the touch operation on the first classification destination image are performed, via the operation detection unit; and
the subconscious mind estimation unit is configured to estimate the subconscious mind of the subject about the tie between the first type concept and the second type concept based on the first operation trajectory.

4. The subconscious mind estimation system according to claim 3, wherein the subconscious mind estimation unit is configured to evaluate a divergence between the first operation trajectory and a predetermined operation trajectory and to estimate the subconscious mind of the subject such that, when the divergence is smaller, there is a stepwise or continuous stronger tie in combination of the first type concept and the second type concept displayed on the image display unit.

5. The subconscious mind estimation system according to claim 4, wherein:
the classification processing unit is configured to display M second classification destination images, which are still images or moving images each including at least one of characters, a symbol, a numeral, a figure, an object image, a pattern, and a color representing each of the first type concept or the second type concept, and a second target image, which includes at least one of characters, a symbol, a numeral, a figure, an object image, a pattern, and a color corresponding to one of the concepts illustrated in the M second classification destination images, on the image display unit and to recognize a second operation trajectory, which is a trajectory of touch operations of the subject obtained until both of the touch operation on the second target image and the touch operation on the second classification destination image are performed, via the operation detection unit; and
the subconscious mind estimation unit is configured to set the predetermined operation trajectory based on the second operation trajectory.

6. The subconscious mind estimation system according to claim 5, wherein:
the second classification destination image includes at least one of the same characters, symbol, numeral, figure, object image, pattern, and color as at least one of the characters, symbol, numeral, figure, object image, pattern, and color representing each of the first type concepts included in the first classification destination image or as at least one of the characters, symbol, numeral, figure, object image, pattern, and color representing each of the second type concepts included in the first classification destination image; and
the second target image includes at least one of the same characters, symbol, numeral, figure, object image, pattern, and color as at least one of the characters, symbol, numeral, figure, object image, pattern, and color included in the first target image.

7. The subconscious mind estimation system according to claim 1,
wherein, in the case where both of the first type concept and the second type concept represented by at least one of the characters, symbol, numeral, figure, object image, pattern, and color included in the touched first classification destination image are different from the first type concept or the second type concept associated with at least one of the characters, symbol, numeral, figure, object image, pattern, and color included in the first target image, the subconscious mind estimation unit is configured to estimate the subconscious mind of the subject that there is a weak tie between the first type concept and the second type concept which are associated with at least one of the characters, symbol, numeral, figure, object image, pattern, and color included in the first classification destination image based on the touch operations of the subject collected until both of the touch operation on the first target image and the touch operation on the touched first classification destination image are performed.

8. The subconscious mind estimation system according to claim 1, wherein:
in the case where both of the first type concept and the second type concept represented by at least one of the characters, symbol, numeral, figure, object image, pattern, and color included in the touched first classification destination image are different from the first type concept or the second type concept associated with at least one of the characters, symbol, numeral, figure, object image, pattern, and color included in the first target image, the classification processing unit displays an image for prompting reselection of the first classification destination image for the same first target image on the image display unit; and
the subconscious mind estimation unit is configured to estimate the subconscious mind of the subject about the tie between the first type concept and the second type concept based on touch operations of the subject performed until before the display of the image for prompting reselection, which have been detected by the classification processing unit.

9. A subconscious mind estimation method implemented by a system which includes: an image display unit which displays an image; and an operation detection unit which is formed integrally with the image display unit and is able to detect a touch operation of a subject, the method comprising the steps of:
a first classification destination image display step of displaying M first classification destination images (M is an integer satisfying M≥2, M≤K, and M≤L), which are still images or moving images each including a combination of at least one of characters, a symbol, a numeral, a figure, an object image, a pattern, and a color representing each of K first type concepts (K is an integer satisfying K≥2) and at least one of characters, a symbol, a numeral, a figure, an object image, a pattern, and a color representing each of L second type concepts (L is an integer satisfying L≥2) different from each of the first type concepts;
a first target image display step of displaying a first target image, which is a still image or a moving image including at least one of characters, a symbol, a numeral, a figure, an object image, a pattern, and a color corresponding to any one of the K first type concepts and the L second type concepts on the image display unit;
a classification processing step of continuing to display the first target image on the image display unit until detecting that at least both of a touch operation of the subject on the first target image and a touch operation of the subject on one of the first classification destination images are performed via the operation detection unit; and
a subconscious mind estimation step of estimating a subconscious mind of the subject about a tie between the first type concept and the second type concept based on the touch operations of the subject detected by the classification processing step.

10. A subconscious mind estimation program causing a computer, which includes an image display unit which displays an image and an operation detection unit which is formed integrally with the image display unit and is able to detect a touch operation of a subject, to function as:
a classification processing unit which displays M first classification destination images (M is an integer satisfying M≥2, M≤K, and M≤L), which are still images or moving images each including a combination of at least one of characters, a symbol, a numeral, a figure, an object image, a pattern, and a color representing each of K first type concepts (K is an integer satisfying K≥2) and at least one of characters, a symbol, a numeral, a figure, an object image, a pattern, and a color representing each of L second type concepts (L is an integer satisfying L≥2) different from each of the first type concepts, and a first target image, which is a still image or a moving image including at least one of characters, a symbol, a numeral, a figure, an object image, a pattern, and a color corresponding to any one of the K first type concepts and the L second type concepts on the image display unit, and then continues to display the first target image on the image display unit until detecting that at least both of a touch operation of the subject on the first target image and a touch operation of the subject on one of the first classification destination images are performed via the operation detection unit; and
a subconscious mind estimation unit which estimates a subconscious mind of the subject about a tie between the first type concept and the second type concept based on the touch operations of the subject detected by the classification processing unit.
